(19) United States
(12) Patent Application Publication
(10) Pub. No.: US 2025/0293535 A1
(43) Pub. Date: Sep. 18, 2025

(54) DISCHARGE TREATMENT METHOD

(71) Applicant: HONDA MOTOR CO., LTD., Tokyo (JP)

(72) Inventors: Yushi Fujinaga, Wako-shi (JP); Mitsumasa Sorazawa, Wako-shi (JP); Takayuki Sakata, Wako-shi (JP); Satoru Takahashi, Wako-shi (JP)

(21) Appl. No.: 19/015,046

(22) Filed: Jan. 9, 2025

(30) Foreign Application Priority Data
Mar. 18, 2024 (JP) 2024-042576

(51) Int. Cl. H02J 7/00; H01M 10/44; H01M 10/54

(52) U.S. Cl. CPC H02J 7/005; H01M 10/448; H02J 7/0048; H01M 10/54

(57) ABSTRACT

A discharge treatment method includes: a discharging step of discharging a depleted lithium ion secondary battery to cause lithium to move from a negative electrode of the lithium ion secondary battery to a positive electrode of the lithium ion secondary battery; a charging step of charging the lithium ion secondary battery at a low voltage at which a ratio of lithium returning to the negative electrode is small; a measuring step of measuring a capacity of the lithium ion secondary battery after being charged at the low voltage for a predetermined period of time; and a confirming step of confirming a state of health (SOH) on a basis of the capacity of the lithium ion secondary battery measured, in which charge treatment in the charging step is terminated at a point of time when the SOH of the lithium ion secondary battery reaches a critical point of recovery.

### INCORPORATION BY REFERENCE

The present application claims priority under 35 U.S.C. § 119 to Japanese Patent Application No. 2024-042576 filed on Mar. 18, 2024. The content of the application is incorporated herein by reference in its entirety.

### BACKGROUND OF THE INVENTION

### Field of the Invention

The present invention relates to a discharge treatment method.

### Description of the Related Art

Examples of lithium ion secondary batteries include liquid lithium ion secondary batteries and solid-state batteries. A lithium ion secondary battery includes a positive electrode material, a negative electrode material, and a separator. The positive electrode material can receive lithium from the negative electrode material and give the lithium thereto in a reversible manner.

The positive electrode material is deteriorated by being repeatedly charged and thus reduced in an acceptable amount of lithium, and unfortunately the battery is reduced in capacity and increased in resistance value.

Conventionally, there is known a technique of electrically connecting a spent positive electrode material to metal lithium to perform a discharge treatment so that the positive electrode material is filled with lithium, thereby recycling the positive electrode material (for example, see Japanese Patent Laid-Open No. 2021-18856).

However, since the technique according to Japanese Patent Laid-Open No. 2021-18856 necessitates separation of the positive electrode and preparation of a source of lithium for regeneration of the positive electrode, it takes a long time in relation to the discharge treatment, which is not efficient. Furthermore, according to Japanese Patent Laid-Open No. 2021-18856, it is necessary to charge the battery up to a state of charge of 100% and check the charged battery for the capacity in order to determine whether to terminate the discharge treatment. In this method, the battery may deteriorate again due to the charging process. If the deterioration occurs, a longer period of time is needed for the discharge treatment, which is not efficient.

An object of the present invention is to provide a discharge treatment method for efficiently regenerating a battery.

### SUMMARY OF THE INVENTION

The discharge treatment method according to the present disclosure includes: a discharging step of discharging a depleted lithium ion secondary battery to cause lithium to move from a negative electrode of the lithium ion secondary battery to a positive electrode of the lithium ion secondary battery; a charging step of charging the lithium ion secondary battery at a low voltage at which a ratio of lithium returning to the negative electrode is small; a measuring step of measuring a capacity of the lithium ion secondary battery after being charged at the low voltage for a predetermined period of time; and a confirming step of confirming a state of health (SOH) on a basis of the capacity of the lithium ion secondary battery measured, in which charge treatment in the charging step is terminated at a point of time when the SOH of the lithium ion secondary battery reaches a critical point of recovery.

According to the discharge treatment method of the present disclosure, a target battery can be efficiently regenerated.

### BRIEF DESCRIPTION OF THE DRAWINGS

FIG. 1 is a view illustrating the configuration of a target battery serving as an example to which the present disclosure is applied;

FIG. 2 is a flowchart of a discharge treatment method for the target battery;

FIG. 3 is a chart illustrating charge/discharge timings for the target battery;

FIG. 4 illustrates an example of a data set representing a capacity SOH, a voltage, and a capacity; and

FIG. 5 is a graph schematically illustrating the transition of a battery capacity.

### DETAILED DESCRIPTION OF THE INVENTION

### Embodiments

### [1. Configuration of Target Battery]

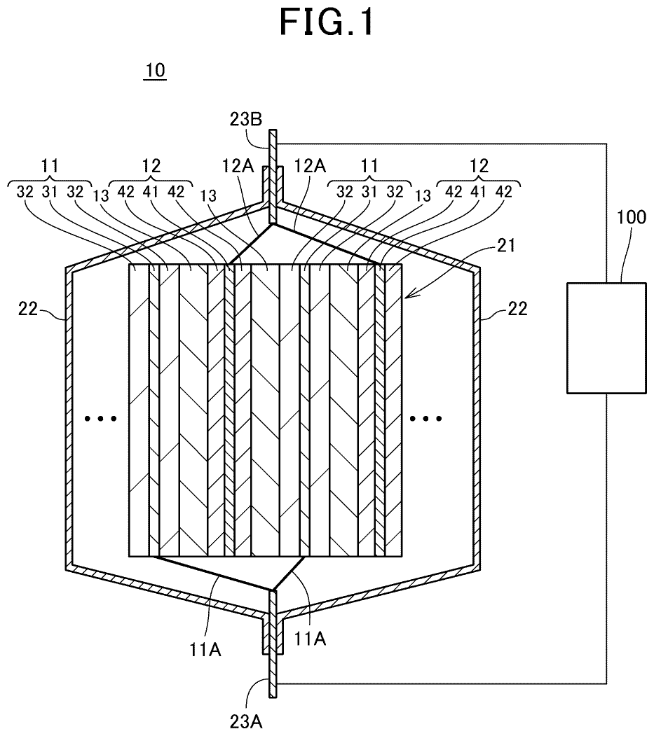

FIG. 1 is a view illustrating the configuration of a target battery 10 which is an example of a battery to which the present disclosure is applied, in which a cross section of the target battery 10 is schematically illustrated. The target battery 10 is a secondary battery which can be charged and discharged. The target battery 10 described in the present embodiment is a laminated battery having laminate materials 22 that enclose battery materials. The target battery 10 has a flat plate shape as a whole. The target battery 10 may be a pouch battery, a laminated battery cell, a pouch battery cell, a lithium ion battery cell, a battery module, or the like.

The target battery 10 is a secondary battery that is so-called a lithium ion battery, which has been attracting attention as an electric storage device that exhibits high energy density. Examples of a positive electrode active material for lithium ion batteries include lithium cobalt oxide, lithium nickel oxide, lithium manganese oxide, and lithium iron phosphate. Examples of the positive electrode active material further include a ternary positive electrode material containing nickel, cobalt, and manganese (NCM). Examples of a negative electrode active material for lithium ion batteries include carbon materials. Solid-state batteries are also known, which are lithium ion batteries having a solid electrolyte as an electrolyte.

As illustrated in FIG. 1, the target battery 10 has the laminate materials 22 that house a laminated electrode 21. Examples of the laminate materials 22 include a laminate film containing a metal material as a base material, such as an aluminum alloy and a stainless steel. The laminate materials 22 function as an exterior body of the target battery 10 and as a sealing body for sealing the laminated electrode 21.

The target battery 10 of the present embodiment has a flat shape composed of two laminate materials 22 bonded together. A pair of current collecting tabs 23A and 23B for extracting electric power from the target battery 10 exposes at the ends of the target battery 10 through the exterior body.

The laminated electrode 21 is a multilayer body including positive electrode plates 11 (positive electrodes) and negative electrode plates 12 (negative electrodes) layered on one another. A separator 13 is disposed between each positive electrode plate 11 and negative electrode plate 12 to prevent a short circuit between the positive electrode plate 11 and the negative electrode plate 12.

The positive electrode plates 11 and the negative electrode plates 12 are alternately disposed. Every pair of positive electrode plate 11 and negative electrode plate 12 opposing each other constitutes a pair of polar plates. Multiple pairs of polar plates are layered on one another to constitute the laminated electrode 21.

The positive electrode plates 11 each include a positive electrode current collector 31 having a rectangular plate shape, and positive electrode composite materials 32 provided on both surfaces of the positive electrode current collector 31. The positive electrode current collector 31 is an aluminum material in the form of a foil or plate. The positive electrode composite material 32 contains, for example, a positive electrode active material, a conducting material, a conductive aid, and a binder. Each positive electrode plate 11 has a positive electrode terminal 11A extending from the end of the positive electrode plate 11. Each of the positive electrode terminals 11A extending from the plurality of positive electrode plates 11 composing the laminated electrode 21 is connected to the current collecting tab 23A.

The negative electrode plates 12 each include a negative electrode current collector 41 having a rectangular plate shape. The negative electrode current collector 41 is provided with negative electrode composite materials 42 on the surfaces facing the positive electrode plates 11. Examples of the negative electrode current collector 41 include a copper foil. Each negative electrode plate 12 has a negative electrode terminal 12A extending from the end of the negative electrode plate 12. Each of the negative electrode terminals 12A extending from the plurality of negative electrode plates 12 composing the laminated electrode 21 is connected to the current collecting tab 23B.

The current collecting tabs 23A and 23B are formed of a metal material in a thin-plate shape such as copper or aluminum, and are exposed to the outside through the two laminate materials 22.

In the case where the target battery 10 is a liquid lithium ion battery, the inside of the laminate materials 22 is filled with a liquid or gel electrolyte solution. The electrolyte solution contains, for example, an electrolyte, a solvent, and an additive. Examples of the electrolyte include lithium salts such as lithium hexafluorophosphate (LiPF6). Examples of the solvent and additive include carbonate esters such as ethylene carbonate, dimethyl carbonate, diethyl carbonate, and vinylene carbonate. These are just examples, and the electrolyte, solvent, and additive may be appropriately selected or changed.

In the case where the target battery 10 is a solid-state battery, the inside of the laminate materials 22 is provided with a solid electrolyte. Oxide electrolytes and sulfide electrolytes are known as examples of the solid electrolyte, but solid-state batteries composed of other materials may fall within the scope of the present disclosure. The solid electrolyte of the solid-state battery is disposed between the positive electrode plate 11 and the negative electrode plate 12 instead of the separator 13. In this case, the solid electrolyte has not only a function as an electrolyte but also a function of preventing a short circuit between the positive electrode plate 11 and the negative electrode plate 12.

Furthermore, in the case where the target battery 10 is a solid-state battery, the negative electrode composite material 42 of the negative electrode plate 12 may contain metal lithium. That is, the negative electrode composite material 42 may be composed of elementary lithium. In the case where metal lithium is employed as a negative electrode active material layer of the negative electrode composite material 42, the metal lithium and the negative electrode current collector 41 are bonded together by a clad material or the like.

The present embodiment discloses a discharge treatment method that is particularly suitable in the case where the target battery 10 is a solid-state battery and, furthermore, the negative electrode composite material 42 contains metal lithium.

### [2. Discharge Treatment Method]

Next, the discharge treatment method for the target battery 10 will be described.

The target battery 10 is a used battery, which is deteriorated and therefore is depleted in discharge capacity (capacity) (mAh).

The target battery 10 is connected to a battery tester 100. The battery tester 100 can apply any voltage to the target battery 10, measure the voltage and current of the target battery 10, and determine the capacity (mAh) of the target battery 10.

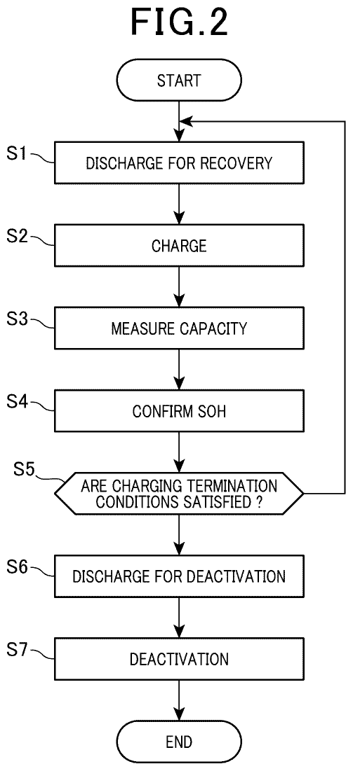

FIG. 2 is a flowchart of the discharge treatment method for the target battery 10.

First, a full-discharge voltage is applied to the target battery 10 for a predetermined period of time, and thereby the battery is discharged (Step S1). The full-discharge voltage is a voltage at which the target battery 10 reaches a state of charge of 0%. The state of charge may be also referred to as SOC.

Step S1 is an example of a discharging step.

By discharging the target battery 10 at the full-discharge voltage, lithium moves from the negative electrode plate 12 to the positive electrode plate 11.

Due to the movement of lithium, the capacity (mAh) of the target battery 10 increases. That is, the state of health (SOH) of the target battery 10 can be recovered. The SOH represents the deterioration state in capacity (mAh) of secondary batteries in terms of %. The discharge at Step S1 is for SOH recovery of the target battery 10.

Next, a low voltage is applied to the target battery 10 for a predetermined period of time so that the target battery 10 is charged (Step S2). The low voltage is set to be low enough that the lithium having moved to the positive electrode plate 11 due to the discharge in Step S1 only slightly returns to the negative electrode plate 12, that is, such that a ratio of lithium returning to the negative electrode plate 12 is small.

Step S2 is an example of a charging step.

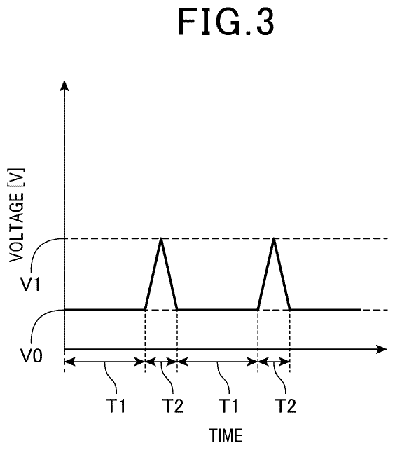

FIG. 3 is a timing chart illustrating charge/discharge timings for the target battery.

Regarding application of a low voltage here, a full-discharge voltage V0 is applied for a predetermined period of time T1 and a low voltage V1 is subsequently applied for a predetermined period of time T2, and then such a voltage application cycle is repeated, as illustrated in FIG. 3. The time T2 is set to be shorter than the time T1. The low voltage V1 being applied exhibits a pulse waveform. The charging time by application of the low voltage V1 is short, so that lithium is prevented from returning too much to the negative electrode plate 12.

If the target battery 10 is charged at a high voltage, too much lithium returns from the positive electrode plate 11 to the negative electrode plate 12. Too much lithium returning to the negative electrode plate 12 can lead to a decrease in the whole amount of lithium that has moved from the negative electrode plate 12 to the positive electrode plate 11 as the target battery 10 is discharged at Step S1 performed after returning from Step S3, which will be described later.

In order to reduce the risk described above, a low voltage is applied.

The low voltage corresponds to a voltage of a new lithium ion battery exhibiting a state of charge of 30%. The new lithium ion battery is namely the target battery 10 exhibiting a SOH (state of health) of 100%. The state of charge of 30% is merely an example of a low state of charge, and it is desirably 20% to 30%.

Next, the capacity (mAh) of the target battery 10 having charged at the low voltage V1 is measured with the battery tester 100 (Step S3).

Step S3 is an example of a measuring step.

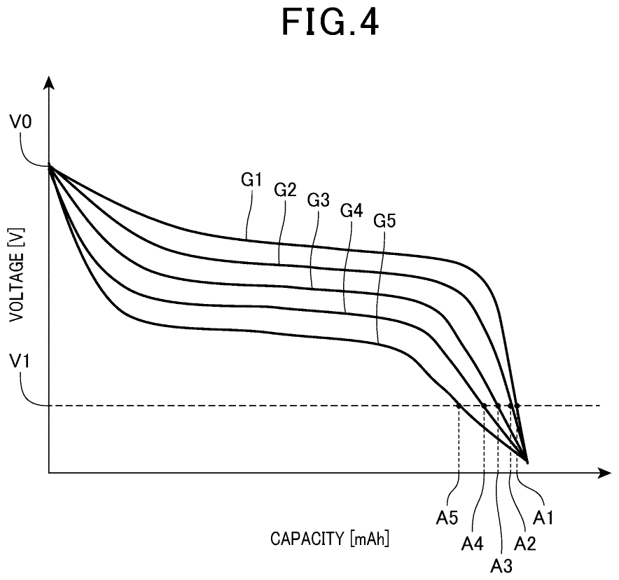

Next, the SOH of the target battery 10 is confirmed with reference to the data set shown in FIG. 4, on the basis of the capacity (mAh) of the target battery 10 having measured (Step S4).

Step S4 is an example of a confirming step.

FIG. 4 illustrates an example of the data set, in which the vertical axis represents the voltage V whereas the horizontal axis represents the capacity (mAh).

A graph G1 is a curve for a new battery serving as a reference battery, exhibiting a SOH (state of health) of 100%. The new battery is a battery that has not been used and is not depleted.

A graph G2 is a curve for a target battery 10 exhibiting a SOH of 95%.

A graph G3 is a curve for a target battery 10 exhibiting a SOH of 90%.

A graph G4 is a curve for a target battery 10 exhibiting a SOH of 85%.

A graph G5 is a curve for a target battery 10 exhibiting a SOH of 80%.

The graph G1 is a curve obtained by measuring the capacity (mAh) by applying a voltage to a new battery. The graphs G2 to G5 are curves obtained by measuring the capacity (mAh) by applying a voltage to target batteries 10 exhibiting a SOH (state of health) of 958, 90%, 85%, and 80%, respectively.

The categories of SOH (state of health) are merely an example, and are not limited to five categories of 100% to 80%. Each of the graphs G1 to G5 represents a correlation between the SOH and the capacity (mAh).

With reference to FIG. 4, in the case where the value of capacity (mAh) measured by the battery tester 100 during application of a low voltage V1 to the target battery 10 corresponds to the point A5 on the graph G5, the SOH (state of health) of the target battery 10 is confirmed to correspond to 80%.

Similarly, in the case of the value of capacity (mAh) corresponding to the point A4 on the graph G4, the SOH (state of health) of the target battery 10 is confirmed to correspond to 858. In the case of the point A3 on the graph G3, the SOH (state of health) of the target battery 10 is confirmed to correspond to 90%. In the case of the value of capacity (mAh) corresponding to the point A2 on the graph G2, the SOH (state of health) of the target battery 10 is confirmed to correspond to 95%. In the case of the point Al on the graph G1, the SOH (state of health) of the target battery 10 is confirmed to correspond to 100%.

According to the present embodiment, lithium is caused to move from the negative electrode plate 12 to the positive electrode plate 11 by discharging the target battery 10 by application of the full-discharge voltage (Step S1), and therefore, the necessity of a source of lithium for regeneration of the positive electrode, which has conventionally been used, is eliminated.

According to the present embodiment, the target battery 10 is charged by application of a low voltage (Step S2), and therefore, lithium having moved to the positive electrode plate 11 only slightly returns to the negative electrode plate 12. Since the amount of lithium returning to the negative electrode plate 12 is small, the whole amount of lithium that has moved from the negative electrode plate 12 to the positive electrode plate 11 as the target battery 10 is discharged again (Step S1) is not likely to decrease.

In the present embodiment, the data set is prepared (FIG. 4) which represents the correlation between the SOH and the capacity (mAh) of the target battery 10. The capacity (mAh) of the target battery 10 is measured while application of the low voltage V1 thereto, and then the SOH is confirmed on the basis of the measured capacity (mAh) with reference to the data set. With this process, it can be confirmed that the SOH is recovered due to the movement of lithium to the positive electrode plate 11. This method can prevent deterioration of the battery and reduce the period of time taken for the discharge treatment, and therefore improve the efficiency, as compared to the conventional method in which the battery is charged up to a state of charge of 100% and then the SOH is confirmed.

Next, it is determined whether charging termination conditions are satisfied (Step S5). In the case where the charging termination conditions are satisfied, the process proceeds to Step S6, whereas in the case where the conditions are not satisfied, the process returns to Step S1.

Step S5 is an example of a determining step.

The determination whether charging termination conditions are satisfied is made depending on whether the SOH (state of health) has reached a critical point of recovery by application of the low voltage V1. The determination whether the critical point of recovery is reached is an example of the determination whether the charging termination conditions are satisfied. To reach the critical point of recovery means that the value of the SOH confirmed in Step S4 becomes greater than or equal to the value of the critical point of recovery.

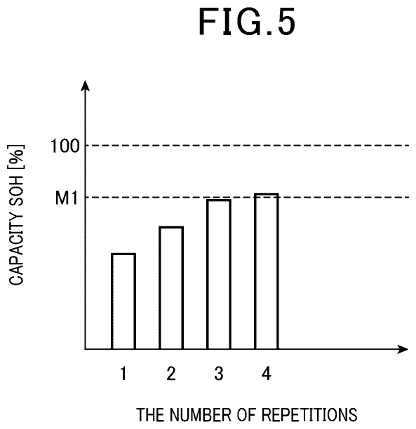

FIG. 5 is an explanatory diagram of the critical point of recovery. The vertical axis represents the SOH of the target battery 10, whereas the horizontal axis represents the number of repetitions of Step S1 to Step S5.

In the case where the SOH confirmed in the first Step S4 has not reached the critical point of recovery M, the process returns to Step S1 of FIG. 2, and Step S1 to Step S5 are repeated. In the case where the critical point of recovery M has still not been reached in the second confirmation, the third confirmation is performed. In the case where the critical point of recovery M has still not been reached, the fourth confirmation is performed. The critical point of recovery M has been reached in the fourth confirmation, and therefore at this point, it is determined that the charging termination conditions are satisfied.

In regard to the confirmation described above, it is not limited to the repetition of Step S1 to Step S5 a plurality of times. In the case where the critical point of recovery M is reached at the first confirmation, for example, it may be determined that the charging termination conditions are satisfied at that point.

Although it is determined that the charging termination conditions are satisfied once the critical point of recovery M is reached according to the above, but this is not limiting. For example, it may be determined that the charging termination conditions are satisfied when the critical point of recovery M is reached a plurality of times.

According to the present embodiment, the charge treatment is terminated at the point of time when the SOH reaches the critical point of recovery M, and therefore time needed for the charge treatment can be reduced. Note that the critical point of recovery M is determined in advance according to the type of target battery 10.

In Step S6, the target battery 10 is discharged by application of the full-discharge voltage for a predetermined period of time. This causes the lithium having moved to the negative electrode plate 12 due to the charge in Step S2 to be moved to the positive electrode plate 11. The discharge in Step S6 is preferably performed before the subsequent deactivation of the negative electrode plate 12 of the target battery 10. The discharge in Step S6 is for the purpose of deactivation of the target battery 10.

Subsequently, the target battery 10 is deactivated with steam (Step S7). The deactivation with steam of the target battery 10 is suitable in the case where the target battery 10 is a solid-state battery.

Step S7 is an example of a deactivating step.

In Step S7, the target battery 10 is cut and placed in a high-humidity container filled with steam. This causes the target battery 10 to be filled with steam, and thereby the target battery 10 is deactivated. The solid-state battery includes a sulfide electrolyte. Accordingly, a gas of a compound containing sulfur is generated and ventilation is to be performed. Since the battery is placed under the steam atmosphere, at least part of lithium in the contents of the solid-state battery is changed into a lithium compound such as lithium hydroxide, which is reduced in activity and becomes safe.

According to the present embodiment, the content of lithium in the negative electrode plate 12 is reduced through repetition of Steps S1 to S5. The target battery 10 is placed under the steam atmosphere while the negative electrode plate 12 of the solid-state battery contains a reduced amount of lithium, and therefore the deactivation can be more safely performed.

Although hydrogen sulfide generated in Step S7 causes corrosion of aluminum of the positive electrode current collector 31 and copper of the negative electrode current collector 41, the corrosion can be minimized in Step S7, since the time for which the positive electrode current collector 31 and the negative electrode current collector 41 are exposed to the hydrogen sulfide atmosphere is reduced due to the reduced period of time needed for deactivation, because of the reduced amount of lithium contained in the negative electrode plate 12 of the solid-state battery.

Since the positive electrode composite material 32, the solid electrolyte, and the negative electrode composite material 42 of the solid-state battery are press-bonded together, it is difficult to take out the positive electrode plate 11.

According to the present embodiment, the positive electrode active material included in the positive electrode composite material 32 of the positive electrode plate 11 can be recovered and therefore the SOH of the target battery 10 can be recovered, without disassembling the target battery 10.

In the case where the negative electrode plate 12 contains metal lithium, the solid-state battery can include a greater amount of lithium, which improves the battery in terms of efficiency, but a problem remains in terms of safety in recycling. According to the discharge treatment method of the present embodiment, the amount of active lithium contained in the negative electrode plate 12 can be reduced, and therefore the safety in recycling can be improved.

### Another Embodiment

In another embodiment, the target battery 10 is further connected to a resistance meter (not illustrated).

A plurality of lithium ion secondary batteries which differ from each other in resistance value SOH are prepared, and a low voltage is applied to each lithium ion secondary battery to measure the resistance value while the low voltage is applied. In this manner, a data set representing a correlation with the resistance value SOH is prepared in advance.

In the other embodiment, the degree of recovery in resistance value SOH of the target battery 10 as compared to the resistance value measured during the application of the low voltage can be confirmed with reference to the data set. In this case, the charging termination conditions of Step S5 shown in FIG. 2 further include a condition that the resistance value of the target battery 10 is less than or equal to a predetermined resistance value threshold. With this, it can be confirmed that the target battery 10 is recovered and thus the resistance value is reduced.

### [Configurations Supported by the Above Embodiment]

The above embodiment supports the following configurations.

(Configuration 1) A discharge treatment method including: a discharging step of discharging a depleted lithium ion secondary battery to cause lithium to move from a negative electrode of the lithium ion secondary battery to a positive electrode of the lithium ion secondary battery; a charging step of charging the lithium ion secondary battery at a low voltage at which a ratio of lithium returning to the negative electrode is small; a measuring step of measuring a capacity of the lithium ion secondary battery after being charged at the low voltage for a predetermined period of time; and a confirming step of confirming a state of health (SOH) on a basis of the capacity of the lithium ion secondary battery measured, in which charge treatment in the charging step is terminated at a point of time when the SOH of the lithium ion secondary battery reaches a critical point of recovery.

According to the configuration 1, since the target battery being a lithium ion battery is charged by application of a low voltage and then the capacity of the target battery can be confirmed, deterioration of the target battery can be prevented. Furthermore, a discharge treatment can be performed without disassembling the target battery. Therefore, the target battery can be efficiently regenerated.

(Configuration 2) The discharge treatment method according to the configuration 1, in which a data set representing a correlation between the SOH of the lithium ion secondary battery and the capacity of the lithium ion secondary battery is prepared, and in the confirming step, the SOH of the lithium ion secondary battery is confirmed on a basis of the capacity of the lithium ion secondary battery with reference to the data set.

According to the configuration 2, it can be determined whether to terminate the charge treatment on the basis of the correlation between the SOH and the capacity. Therefore, the target battery can be regenerated with high accuracy.

(Configuration 3) The discharge treatment method according to the configuration 1, further including: a determining step of determining whether charging termination conditions are satisfied, in which in a case where the charging termination conditions are not satisfied, a process returns to the discharging step, and the charging step, the measuring step, and the confirming step are repeated.

According to the configuration 3, since the SOH can be repeatedly confirmed, the discharging step is prevented from being performed more than necessary in disregard of the recovery in capacity SOH, and therefore the efficiency in the discharge treatment can be improved.

(Configuration 4) The discharge treatment method according to the configuration 3, in which in the determining step, it is determined that the charging termination conditions are not satisfied in a case where the SOH confirmed does not reach the critical point of recovery.

According to the configuration 4, the timing of terminating the repetition of the discharging step and the charging step can be determined.

(Configuration 5) The discharge treatment method according to the configuration 3 or 4, in which in the measuring step, a resistance value of the lithium ion secondary battery is measured, and in the determining step, it is determined that the charging termination conditions are not satisfied in a case where the resistance value is less than or equal to a predetermined threshold.

According to the configuration 5, since the deterioration state can be confirmed in terms of not only the capacity but also the resistance value, the degree of regeneration of the target battery being a lithium ion battery can be confirmed in more detail.

(Configuration 6) The discharge treatment method according to the configuration 1, in which the lithium ion secondary battery is a solid-state battery, and the negative electrode contains metal lithium, and the method further includes a deactivating step of deactivating the solid-state battery with steam.

According to the configuration 6, even a solid-state battery, which is barely disassembled to allow extraction of the positive electrode or the negative electrode, can be subjected to the discharge treatment and recovered in SOH. In addition, since the amount of lithium of the negative electrode is reduced due to the discharging step, the deactivating step can be stably performed.

### REFERENCE SIGNS LIST

10: Target battery, 11: Positive electrode plate (Positive electrode), 12: Negative electrode plate (Negative electrode), 13: Separator, 21: Laminated electrode, 22: Laminate material, 22A, 22B: Current collecting tab, 31: Positive electrode current collector, 32: Positive electrode composite material, 41: Negative electrode current collector, 42: Negative electrode composite material, 100: Battery tester

1. A discharge treatment method comprising:
a discharging step of discharging a depleted lithium ion secondary battery to cause lithium to move from a negative electrode of the lithium ion secondary battery to a positive electrode of the lithium ion secondary battery;
a charging step of charging the lithium ion secondary battery at a low voltage at which a ratio of lithium returning to the negative electrode is small;
a measuring step of measuring a capacity of the lithium ion secondary battery after being charged at the low voltage for a predetermined period of time; and
a confirming step of confirming a state of health (SOH) on a basis of the capacity of the lithium ion secondary battery measured, wherein
charge treatment in the charging step is terminated at a point of time when the SOH of the lithium ion secondary battery reaches a critical point of recovery.

2. The discharge treatment method according to claim 1, wherein
a data set representing a correlation between the SOH of the lithium ion secondary battery and the capacity of the lithium ion secondary battery is prepared, and
in the confirming step,
the SOH of the lithium ion secondary battery is confirmed on a basis of the capacity of the lithium ion secondary battery with reference to the data set.

3. The discharge treatment method according to claim 1, further comprising:
a determining step of determining whether charging termination conditions are satisfied, wherein
in a case where the charging termination conditions are not satisfied, a process returns to the discharging step, and the charging step, the measuring step, and the confirming step are repeated.

4. The discharge treatment method according to claim 3, wherein
in the determining step,
it is determined that the charging termination conditions are not satisfied in a case where the SOH confirmed does not reach the critical point of recovery.

5. The discharge treatment method according to claim 3, wherein
in the measuring step, a resistance value of the lithium ion secondary battery is measured, and
in the determining step, it is determined that the charging termination conditions are not satisfied in a case where the resistance value is less than or equal to a predetermined threshold.

6. The discharge treatment method according to claim 1, wherein
the lithium ion secondary battery is a solid-state battery, and the negative electrode contains metal lithium, and
the method further comprises a deactivating step of deactivating the solid-state battery with steam.
